(19) United States
(12) Patent Application Publication
(10) Pub. No.: US 2008/0045440 A1
(43) Pub. Date: Feb. 21, 2008

(54) Anti-Malodour Composition

(75) Inventor: Matthew Elliot Helton, Bebington (GB)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(73) Assignee: CONOPCO, INC. D/B/A UNILEVER, Englewood Cliffs, NJ (US)

(21) Appl. No.: 11/464,968

(22) Filed: Aug. 16, 2006

(51) Int. Cl. C11D 3/37

(52) U.S. Cl. 510/499; 510/504

(57) ABSTRACT

The present concerns the use of an anti-malodour component. The anti-malodour component is a cationic species having a triiodide counter ion.

### FIELD OF INVENTION

The present invention relates to an anti-malodour laundry detergent composition and use thereof.

### BACKGROUND OF THE INVENTION

European Patent 303,520 discloses cationic nitrides.

European patent 382 562 discloses polymeric ammonium triiodides and there use as disinfectants.

U.S. Pat. No. 6,811,771 discloses an antimicrobial organic polymer material. The organic polymer material has a polymer side chain containing a unit derived from an N-alkyl-N-vinylalkylamide on a backbone of a polymer substrate; a triiodide ion is carried on the organic polymer material.

U.S. Pat. No. 3,817,860, issued 18 Jun. 1974, discloses an iodine/resin disinfectant and a procedure for the preparation thereof. The iodine/resin is prepared from an anionic exchange resin and an iodine/iodide mixture.

U.S. Pat. No. 8,899,868 discloses an iodine/resin disinfectant and a procedure for the preparation thereof.

U.S. Pat. No. 6, 680,050 discloses an iodine/resin disinfectant and a procedure for the preparation thereof.

WO 04/029354 discloses a bleaching composition comprising:

(a) iodine or a source thereof in the range from 0.0005 wt % to 5.0 wt %; and,

(b) the balance carriers and adjunct ingredients.

### SUMMARY OF INVENTION

We have found that a cationic species with triiodide counter ion serves to reduce malodour in clothes that arise as a result of bodily secretions.

In one aspect the present invention provides a laundry treatment composition comprising:

(i) from 2 to 70 wt % of a surfactant, and a cationic species, wherein the cationic species has as a counter ion triiodide.

It is preferred that the cationic species is present in the composition in an amount from 0.00001 to 20 wt %, preferably 00001 to 5 wt %, more preferably 0.001 to 1 wt %.

In another aspect the present invention provides a method of treating a textile comprising the following steps:

(i) treating a textile with from the laundry treatment composition in an aqueous medium, wherein the aqueous medium comprises from of 0.5 g/L to 30 g/l of the laundry treatment composition, the aqueous medium having a pH in the range 4 to 11; and,

(ii) rinsing the textile with water; and, (iii) drying the textile. The method is preferably a domestic method and carried out within the home.

It is preferred that the composition is added to water such that it provides from 0.2 g/L to 5 g/L of surfactant in the aqueous medium.

The composition may be liquid or solid. If a solid, a granular format is preferred.

The present invention extends to method of pretreating a garment with the composition, in particular armpit areas of a garment.

The present invention also extends to a clothing garment treated with the composition of the invention.

The present invention also extends to a commercial package comprising the laundry treatment composition together with instructions for its use.

### DETAILED DESCRIPTION OF THE INVENTION

### Anti-Malodour Component

The anti-malodour component is the cationic species, having a triiodide counter ion.

The cationic species may be an organic polymer material having a polymer side chain having a unit derived from an N-alkyl-N-vinylalkylamide on a backbone of a polymer substrate; a triiodide ion is carried on the organic polymer material. U.S. Pat. No. 6,811,771 and references found therein provide enablement as to how such species are manufactured. U.S. Pat. No. 6,811,771 is a little over academic as to its description but the polymer and proton per column 5, as described should be construed herein as a cationic species, for example a protonated poly(vinylpyrrolidone) (PVP). Polymer units derived from N-vinylpyrrolidone, 1-vinyl-2-piperidone, N-vinyl-N-methylacetamide, N-vinyl-N-ethylacetamide, N-vinyl-N-methyl propylamide, N-vinyl-N-ethyl propylamide are preferred but PVP is a preferred polymer. Treatment of (PVP) with I2/KI as essentially described below will yield PVP with a triiodide ion.

The polymeric ammonium triiodides as described and enabled in European patent 382 582 are also preferred anti-malodour active compounds for use in the present invention. Preferred examples of which are: poly[(dimethyliminio)-2-hydroxypropylene triiodide], poly[oxyethylene(dimethyliminio)hydroxypropylene (dimethyliminio)ethylenedi(triiodide)]and poly[2-hydroxyethylene (dimethyliminio)ethylene-dimethyliminio)-methylene di(triiodide)].

The anti-malodour component is preferably a quaternary ammonium compound. The triiodide counter ion contains three iodine atoms and which has a valence of −1. The triiodide ion is a complex ion which may be understood to comprise molecular iodine (i.e., I12) and an iodide ion (i.e., I—). The quaternary ammonium compound is most preferably a trimethyl quaternary ammonium compound.

The triiodide counter ion is easily produced. For example iodine may be combined with sodium, potassium or ammonium iodide and some water. The composition will contain monovalent iodide ion that will combine with diatomic iodine (I2) to form polyiodide ion. The molar ratio of iodine ion to diatomic iodine will dictate the nature of the polyiodide ion present, i.e. triiodide ion, mixtures of triiodide ion and other higher polyiodides ions, pentaiodide ion, etc.

Using about 1 mole of iodine ion per mole of diatomic iodine the formation of triiodide ion will be favoured. If stiochiometric excess of diatornic iodine is used this will favour the formation of higher polyiodides.

The quaternary ammonium compound may be a cationic nitrile. Cationic nitrites are of the structure, [R¹R²R³NCH₂CN]⁺ [X⁻], where R¹, R² and R³ are alkyl groups, preferably R¹, R² and R³ are methyl groups. The X⁻ is a triiodide counter ion.

Preferred examples of cationic nitriles are disclosed in EP-A-303,520 and EP 1122300 in European Patent Specification Nos. 458,396 and 464,880.

Another preferred class are quaternary ammonium resins as disclosed in U.S. Pat. No. 6,592,861. The resin is U.S. Pat. No. 6,899,868 discloses an iodine/resin disinfectant and a procedure for the preparation thereof. The resins are insoluble in water. Most preferably the resin is a trimethyl quaternary ammonium compound.

The quaternary ammonium resins having a triiodide counter ion are easily produced. For example, if a triiodide-resin is desired the resin may be contacted with an alkali metal iodide/I2 mix wherein the iodide and the diatomic iodine are present in more or less stoichiometric amounts (i.e. a mole ratio of 1). By applying stoichiometric amounts of the iodine ion and iodine molecule (i.e. one mole of I2 per mole of I—), the iodide sludge will comprise substantially only the triiodide ions. If stoichiometric excess quantities of I2 are used some of the higher polyiodide ions may be formed. Preferably, no more than the stoichiometric proportions of I— and I2 are used in the initial aqueous starting sludge so that substantially only triiodide attaches to the resin. U.S. Pat. Nos. 6,592,861, 6,899,868 and references found therein provide enablement as to how such resins are manufactured. The resins are commercially available, for example the Amberlite series as provides by Rohm and Haas; a preferred example is Amberlite 401-S.

The following is the outline of the procedure from U.S. Pat. No. 6,680,050.

A quaternary ammonium resins having a triiodide counter ion may be obtained by a) bringing a porous, granular, starting resin into contact with an aqueous sludge of iodine and potassium iodide so as to obtain a paste mixture, iodine being present in the sludge essentially as triiodide ions, said starting resin being a strong base anion exchange resin having strongly basic groups thereof in a salt form the anion of which is exchangeable with triiodide ions, b) subjecting the paste mixture to elevated temperature and pressure conditions in an enclosed container or reactor (e.g., autoclave) for a predetermined impregnating duration of time, a void space being provided in the reactor such that contact occurs under an iodine atmosphere, and c) washing the obtained iodide-resin product with a suitable deionised water to remove water elutable iodine such as KI from the surface of the resin so that on drying no iodine crystals will form on the surface of the resin.

The quaternary ammonium resin is preferably ground into a fine powder. The powder is preferably in the range from 1 nanometre to 1000 microns, more preferably from 500 nanometres to 500 microns. The aforementioned sizes are determined by use of appropriately sized sieves or what would pass through or be retained by an appropriately sized sieve. Indeed, this size is preferred when and solid anti-malodour active, i.e., a cationic species with triiodide counter ion, is used in the present invention.

The level of the quaternary ammonium resins having a triiodide counter ion in the laundry composition is preferably from 0.001 to 2 wt %

Triosyn® resin is believed to have utility in the present application.

In order to reduce free iodine in the environment it is preferred that the anti-malodour active is insoluble in water, preferably less than 1 mg/L in water at 20° C., most preferably insoluble per se.

### Balls

In another aspect the present invention provides a shuttle that is used in the wash or soaks to reduce bacteria and fungus. The shuttle is preferably a substantially ball/oval shaped object that is placed into the wash or soak and may be used in a washing machine. The shuttle is water insoluble and incorporates the anti-malodour component which is also preferably water insoluble. In a further aspect, the present invention provides a method of use of the shuttle by adding to an aqueous wash or soak and agitating the medium.

The shuttle may be a container that contains a plurality of small balls in the form of an anion exchange resin that has a triiodide anion. The container/shell of the shuttle permits fluid to readily pass through it contacting the small balls within. The shape of the balls is not essential but the size and shape should permit a good volume to surface area contact ratio. Devices to allow dispersal of detergents will be suitable to hold an anion exchange resin that has a triiodide anion.

### Surfactant

The composition comprises between 2 to 70 wt % of a surfactant, most preferably 10 to 30 wt %. In general, the nonionic and anionic surfactants of the surfactant system may be chosen from the surfactants described “Surface Active Agents” Vol. 1, by Schwartz & Perry, Interscience 1949, Vol. 2 by Schwartz, Perry & Berch, Interscience 1958, in the current edition of “McCutcheon's Emulsifiers and Detergents” published by Manufacturing Confectioners Company or in “Tenside-Taschenbuch”, H. Stache, 2nd Edn., Carl Hauser Verlag, 1981. Preferably the surfactants used are saturated.

Suitable nonionic detergent compounds which may be used include, in particular, the reaction products of compounds having a hydrophobic group and a reactive hydrogen atom, for example, aliphatic alcohols, acids, amides or alkyl phenols with alkylene oxides, especially ethylene oxide either alone or with propylene oxide. Specific nonionic detergent compounds are C₆ to C₂₂ alkyl phenol-ethylene oxide condensates, generally 5 to 25 EO, i.e. 5 to 25 units of ethylene oxide per molecule, and the condensation products of aliphatic C₈ to C₁₈ primary or secondary linear or branched alcohols with ethylene oxide, generally 5 to 40 EO.

Suitable anionic detergent compounds which may be used are usually water-soluble alkali metal salts of organic sulphates and sulphonates having alkyl radicals containing from about 8 to about 22 carbon atoms, the term alkyl being used to include the alkyl portion of higher acyl radicals. Examples of suitable synthetic anionic detergent compounds are sodium and potassium alkyl sulphates, especially those obtained by sulphating higher C₈ to C₁₈ alcohols, produced for example from tallow or coconut oil, sodium and potassium alkyl C₉ to C₂₀ benzene sulphonates, particularly sodium linear secondary alkyl C₁₀ to C₁₅ benzene sulphonates; and sodium alkyl glyceryl ether sulphates, especially those ethers of the higher alcohols derived from tallow or coconut oil and synthetic alcohols derived from petroleum. The preferred anionic detergent compounds are sodium C₁₁ to C₁₅ alkyl benzene sulphonates and sodium C₁₂ to C₁₈ alkyl sulphates. Also applicable are surfactants such as those described in EP-A-328 177 (Unilever), which show resistance to salting-out, the alkyl polyglycoside surfactants described in EP-A-070 074, and alkyl monoglycosides.

Preferred surfactant systems are mixtures of anionic with nonionic detergent active materials, in particular the groups and examples of anionic and nonionic surfactants pointed out in EP-A-346 995 (Unilever). Especially preferred is surfactant system that is a mixture of an alkali metal salt of a C₁₆ to C₁₈ primary alcohol sulphate together with a C₁₂, to C₁₅ primary alcohol 3 to 7 EO ethoxylate.

The nonionic detergent is preferably present in amounts greater than 10%, e.g. 25 to 90 wt % of the surfactant system Anionic surfactants can be present for example in amounts in the range from about 5% to about 40 wt % of the surfactant system.

In another aspect, which is also preferred, the surfactant may he a cationic such that the formulation is a fabric conditioner.

### Fabric Conditioning Cationic Compound

When the present invention is used as a fabric conditioner it needs to contain a fabric conditioning cationic compound.

Most preferred are quaternary ammonium compounds.

It is advantageous if the quaternary ammonium compound is a quaternary ammonium compound having at least one C₁₂ to C₂₂ alkyl chain.

It is preferred if the quaternary ammonium compound has the following formula:

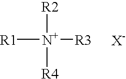

in which R¹ is a C₁₂ to C₂₂ alkyl or alkenyl chain; R², R³ and R⁴ are independently selected from C₁ to C₄ alkyl chains and X⁻ is a compatible anion. A preferred compound of this type is the quaternary ammonium compound cetyltriimethyl quaternary ammonium bromide.

A second class of materials for use with the present invention are the quaternary ammonium of the above structure in which R¹ and R² are independently selected from C₁₂ to C₂₂ alkyl or alkenyl chain; R³ and R⁴ are independently selected from C₁ to C₄ alkyl chains and X⁻ is a compatible anion.

Other suitable quaternary ammonium compounds are disclosed in EP 0 239 910 (Proctor and Gamble).

It is preferred if the ratio of cationic to nonionic surfactant is from 1:100 to 50:50, more preferably 1:50 to 20:50.

The fabric conditioning cationic compound may be present from 1.5 wt % to 50 wt % of the total weight of the composition. Preferably the cationic compound may be present from 2 wt % to 25 wt %, a more preferred composition range is from 5 wt % to 20 wt %.

The softening material is preferably present in an amount of from 2 to 60% by weight of the total composition, more preferably from 2 to 40%, most preferably from 3 to 30% by weight.

The composition optionally comprises a silicone.

### Builder

The composition of the present invention preferably comprises one or more detergency builders. The total amount of detergency builder in the compositions will preferably range from 5 to 80 wt %, more preferably from 10 to 60 wt %.

Inorganic builders that may be present include sodium carbonate, if desired in combination with a crystallisation seed for calcium carbonate, as disclosed in GB 1 437 950 (Unilever); crystalline and amorphous aluminosilicates, for example, zeolites as disclosed in GB 1 473 201 (Henkel), amorphous aluminosilicates as disclosed in GB 1 473 202 (Henkel) and mixed crystalline/amorphous aluminosilicates as disclosed in GB 1 470 250 (Procter & Gamble); and layered silicates as disclosed in EP 164 514B (Hoechst). Inorganic phosphate builders, for example, sodium orthophosphate, pyrophosphate and tripolyphosphate are also suitable for use with this invention.

The compositions of the invention preferably contain an alkali metal, preferably sodium, aluminosilicate builder. Sodium aluminosilicates may generally be incorporated in amounts of from 10 to 70% by weight (anhydrous basis), preferably from 25 to 50 wt %.

The alkali metal aluminosilicate may be either crystalline or amorphous or mixtures thereof, having the general formula; 0.8-1.5 Na₂O₃. Al₂O₃. 0.8-6 SiO₂.

These materials contain some bound water and are required to have a calcium ion exchange capacity of at least 50 mg CaO/g. The preferred sodium aluminosilicates contain 1.5-3.5 SiO₂ units (in the formula above). Both the amorphous and the crystalline materials can be prepared readily by reaction between sodium silicate and sodium aluminate, as amply described in the literature. Suitable crystalline sodium aluminosilicate ion-exchange detergency builders are described, for examples in GB 1 429 143 (Procter & Gamble). The preferred sodium aluminosilicates of this type are the well-known commercially available zeolites A and X, and mixtures thereof.

The zeolite may be the commercially available zeolite 4A now widely used in laundry detergent powders. However, according to a preferred embodiment of the invention, the zeolite builder incorporated in the compositions of the invention is maximum aluminium zeolite P (zeolite MAP) as described and claimed in EP 384 070A (Unilever). Zeolite MAP is defined as an alkali metal aluminosilicate of the zeolite P type having a silicon to aluminium ratio not exceeding 1.33, preferably within the range of from 0.90 to 1.33, and more preferably within the range of from 0.90 to 1.20.

Especially preferred organic builders are citrates, suitably used in amounts of from 5 to 30 wt %, preferably from 10 to 25 wt %; and acrylic polymers, more especially acrylic/maleic copolymers, suitably used in amounts of from 0.5 to 15 wt %, preferably from 1 to 10 wt %.

Builders, both inorganic and organic, are preferably present in alkali metal salt, especially sodium salt, form. It is preferred that the composition comprises from 2 to 30 wt % of sodium carbonate.

### Bleaching Components

The composition may contain peroxygen bleaches and bleach activators. When a peroxygen bleach is present the preferred format is granular. If the quaternary ammonium compound is cationic nitrile then it will function as an activator in itself. Preferred peroxygen bleaches are sodium percarbonate and sodium perborate, most preferred is sodium percarbonate. Activators include amongst other things TAED (((H₃C—CO)₂N—CH₂—CH₂—N(OC—CH₃)₂)) and transition metal catalysts. A preferred range for a peroxygen bleach is from 2 to 25 wt %, most preferably 5 to 15 wt %, in the composition. Preferably the peroxygen bleach is in a different granule to the anti-malodour component. Preferably a peroxygen bleach is only present when the anti-malodour species is insoluble in water.

### Fluorescent Agent

The composition preferably comprises a fluorescent agent (optical brightener). Fluorescent agents are well known and many such fluorescent agents are available commercially. Usually, these fluorescent agents are supplied and used in the form of their alkali metal salts, for example, the sodium salts. The total amount of the fluorescent agent or agents used in the composition is generally from 0.005 to 2 wt %, more preferably 0.01 to 0.1 wt %. Preferred classes of fluorescer are: Di-styryl biphenyl compounds, e.g. Tinopal (Trade Mark) CNS-X, Di-amine stilbene di-sulphonic acid compounds, e.g. Tinopal DMS pure Xtra and Blankophor (Trade Mark) HRH, and Pyrazoline compounds, e.g. Blankophor SN. Preferred fluorescers are: sodium 2(4-styryl-3-sulfophenyl)-2H-napthol[1,2-d]trazole, disodium 4,4′-bis{[(4-anilino-6-(N methyl-N-2 hydroxyethyl)amino 1,3,5-triazin-2-yl)]amino}stilbene-2-2′disulfonate, disodium 4,4′-bis{[(4-anilino-6-morpholino-1,3,5-triazin-2-yl)]amino}stilbene-2-2′ disulfonate, and disodium 4,4′-bis(2-sulfoslyryl) biphenyl.

Perfume

Preferably the composition comprises a perfume. The perfume is preferably in the range from 0.001 to 3 wt % most preferably 0.1 to 1 wt %. Many suitable examples of perfumes are provided in the CTFA (Cosmetic, Toiletry and Fragrance Association) 1992 International Buyers Guide, published by CFTA Publications and OPD 1993 Chemicals Buyers Directory 80th Annual Edition, published by Schnell Publishing Co.

Enzymes as optional ingredients may also be present as found in WO0060045.

### Experimental

The following base detergent is used,

Base Detergent

| Component | Wt % |
|---|---|
| NaLAS | 18.1 |
| Silicate | 7.6 |
| STPP | 10.0 |
| Sodium Sulphate | 42.2 |
| Sodium Carbonate | 13.7 |
| SCMC | 0.30 |
| CBS slurry | 0.11 |
| Savinase 12T | 0.21 |
| Water | 6.0 |
| Other adjuncts to | 100 |

A quaternary ammonium resin having a triiodide counter ion is prepared from Amberlite IR-400, per example 9 of U.S. Pat. No. 6,899,868 . The resin is ground and sieved to provide a fine powder of less than 200 microns.

This powder is then added to the base detergent at a level of 0.1 wt % to provide an anti-malodour formulation.

A cotton swab 5 cm×5 cm is then washed in an aqueous solution 10 g/l with agitation for 30 minutes, rinsed and dried to provide a anti-malodour swab. Another cotton swab 5 cm×5 cm is then washed in the base detergent without the resin as a control to provide a non-anti-malodour swab.

A anti-malodour swab is then placed under one armpit of a test subject and a non-anti-malodour swab is placed under the other armpit of the test subject. The test subject is not washed for 24 hour beforehand and is not treated with any deodorant or antiperspirant in the intervening period before the following test is conducted. The test subject is then exercised for 30 minutes after which the swabs are removed.

After the swabs are left in individual plastic bags at 35° C. for five hours the swabs are removed and subjected to sniffing in a blind test by ten subjects. It is believed that eight out of ten of the subjects would indicate that the non-anti-malodour swab is of a far greater malodour level than the anti-malodour swab.

1. A laundry treatment composition comprising:
(i) from 2 to 70 wt. % of a surfactant, and a cationic species, wherein the cationic species has a counter ion triiodide.

2. A laundry treatment composition according to claim 1, wherein
The cationic species is a polymer comprising a unit derived from an N-alkyl-N-vinylalkylamide.

3. A laundry treatment composition according to claim 1, wherein the cationic species is a quaternary ammonium.

4. A laundry treatment composition according to claim 1, wherein the cationic species is a cationic nitrile.

5. A laundry treatment composition according to claim 1, wherein the cationic species is a resin.

6. A laundry treatment composition according to claim 5, wherein the resin is a strong base anion exchange resin.

7. A laundry treatment composition according to claim 1, wherein the resin or polymer has a particle size from 1 nanometre to 1000 microns.

8. A laundry treatment composition according to claim 7, wherein the resin has a particle size from 500 nanometres to 500 microns.

9. A laundry treatment composition according to claim 1, comprising a builder.

10. A laundry treatment composition according to claim 1, wherein the builder is sodium carbonate.

11. A laundry treatment composition according to claim 1, wherein the composition comprises a perfume in the range from 0.001 to 3 wt %.

12. A method of treating a textile comprising the following steps:
(i) treating a textile with from the laundry treatment composition, as defined in claim 1, in an aqueous medium, wherein the aqueous medium comprises from of 0.5 to 30 g/1 of the laundry treatment composition, the aqueous medium having a pH in the range 4 to 11, and,
(ii) rinsing the textile with water, and,
(iii) drying the textile.
